(19) United States
(12) Patent Application Publication
(10) Pub. No.: US 2025/0057130 A1
(43) Pub. Date: Feb. 20, 2025

(54) TRAWL NET SYSTEM AND SEGMENT

(71) Applicant: Katchi Technologies Incorporated, Tusket (CA)

(72) Inventors: Marc Eric d'Entremont, Tusket (CA); Thomas Kinsey, Québec City (CA); Mark Alan de Jonge, Halifax (CA)

(21) Appl. No.: 18/935,755

(22) Filed: Nov. 4, 2024

Related U.S. Application Data
(63) Continuation of application No. PCT/CA2023/050634, filed on May 10, 2023.
(60) Provisional application No. 63/341,194, filed on May 12, 2022.

(51) Int. Cl. A01K 73/045

(52) U.S. Cl. CPC A01K 73/045

(57) ABSTRACT

A segment for use in a trawl system having a cable and a longitudinal axis. The segment has a segment body and at least one passage extending from an inner side to an outer side of the body for receiving the cable of the trawl system. The segment body is hydrodynamically shaped such that the segment is urged away from the longitudinal axis when the segment is pulled through water by the cable. A trawl net system is also disclosed.

### CROSS-REFERENCE TO RELATED APPLICATIONS

This application is a continuation of International Application No. PCT/CA2023/050634 filed on May 10, 2023, which claims the benefit of U.S. Provisional Application No. 63/341,194 filed on May 12, 2022. The entire contents of both of the above applications are incorporated herein by reference.

### FIELD

This disclosure relates generally to trawl nets, and more specifically to trawl net systems and segments for use in such systems.

### INTRODUCTION

In a typical trawl net system, trawl doors are used help to spread the net open as it is pulled through the water. The trawl doors are typically coupled to the actual net by e.g., sweeps and bridles. Ground gear (which may include large rubber disks), the footrope, sweeps, and/or the trawl doors may be in intermittent or constant contact with the bottom of the body of water through which the trawl net is being towed (e.g., the sea floor).

A possible disadvantage of known trawl net systems is that the trawl doors may exert significant drag as they are pulled through a body of water and/or along its bottom. This may require more power to be exerted by the vessel(s) towing the trawl net, which may increase fuel consumption, wear and tear, and/or damage to the seabed.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

In at least one aspect there is provided a segment for use in a trawl system having a cable and a longitudinal axis, the segment comprising:
a segment body having an inner side, and an outer side; and
at least one passage extending from the inner side to the outer side for receiving the cable of the trawl system;
wherein the segment body is hydrodynamically shaped such that the segment is adapted to be urged away from the longitudinal axis when the segment is pulled through water by the cable.

In any embodiment, the segment body may be shaped such that when the segment is pulled through water, the inner side forms a high pressure region and the outer side forms a low pressure region and a pressure gradient between the inner side and the outer side generates a lateral lift force that urges the segment in a direction away from the longitudinal axis.

In any embodiment, the inner side of the segment body may be generally planar.

In any embodiment, the outer side of the segment body may be generally convex.

In any embodiment, the segment body may be a spherical dome.

In any embodiment, the at least one passage may have a passage longitudinal axis that forms an incidence angle with a flow direction when the segment is pulled through water, and wherein the incidence angle may be based on a ratio of lateral lift force to drag force.

In any embodiment, the incidence angle may be in the range of about 0 to about 30 degrees.

In any embodiment, the ratio may be above about 1.5.

In any embodiment, the at least one passage may comprise a plurality of passages for receiving a plurality of the cables, wherein when each one of the plurality of passages receives a corresponding one of the plurality of cables, the segment is restrained from rolling.

In accordance with another aspect there is provided a trawl net system, comprising:
a trawl net having a first side and a second side with an opening therebetween;
a first bridle adapted to be coupled to the first side and a second bridle adapted to be coupled to the second side, each bridle comprising at least one cable;
a first plurality of segments and a second plurality of segments, wherein each segment of the first and second plurality of segments comprises:
a segment body having an inner side, and an outer side; the segment body defining at least one passage extending therethrough from the inner side to the outer side for receiving the at least one cable;
wherein the first plurality of segments is positionable on the first bridle and the second plurality of segments is positionable on the second bridle,
wherein each segment body is hydrodynamically shaped such that the first plurality of segments and the second plurality of segments are adapted to be urged away from each other when the segments are pulled through water by the bridles.

In any embodiment, at least one of the first bridle and the second bridle may comprise a plurality of cables and each segment in the corresponding plurality of segments comprises a plurality of passages for receiving the plurality of cables.

In any embodiment, the trawl net system may further comprise:
a third bridle couplable to the first side and a fourth bridle couple to the second side, each of the third and fourth bridles having the at least one cable;
a third plurality of the segments positionable on the third bridle and a fourth plurality of the segments positionable on the fourth bridle,
wherein the third plurality of segments and the fourth plurality of segments are adapted to be urged away from each other when the segments are pulled through water by the bridles.

In any embodiment, at least one of the first bridle, the second bridle, the third bridle, and the fourth bridle may comprise a plurality of cables and each segment in the corresponding plurality of segments may define a plurality of passages for receiving the plurality of cables.

In any embodiment, the trawl net system may further comprise a first connecting cable for connecting the first bridle to the third bridle and a second connecting cable for connecting the second bridle to the fourth bridle.

In any embodiment, each segment may have a center point and a length extending from a leading edge to a trailing edge and each plurality of segments may be distributed along the respective bridle with an inter-segment distance that reduces shielding between adjacent segments.

In any embodiment, the inter-segment distance may be greater than two lengths of the segment.

In any embodiment, the first side may be a first lateral side and the second side may be a second lateral side.

It will be appreciated by a person skilled in the art that a method or apparatus disclosed herein may embody any one or more of the features contained herein and that the features may be used in any particular combination or sub-combination.

These and other aspects and features of various embodiments will be described in greater detail below.

### BRIEF DESCRIPTION OF THE DRAWINGS

For a better understanding of the described embodiments and to show more clearly how they may be carried into effect, reference will now be made, by way of example, to the accompanying drawings in which:

FIG. 1 is a perspective view of a trawl net system in accordance with one embodiment;

FIG. 2 is a perspective view of the headline of FIG. 1;

FIG. 3 is a top plan view of the headline of FIG. 2;

FIG. 4 is a section view of the headline of FIG. 2, taken along line 4-4 in FIG. 2;

FIG. 5 is a top plan view of the headline of FIG. 2, with the headline segments separated from each other;

FIG. 6 is a section view of the headline of FIG. 2, with the headline segments separated from each other;

FIG. 7 is a perspective view of a headline segment in accordance with one embodiment;

FIG. 8 is another perspective view of the headline segment of FIG. 7;

FIG. 9 is a top plan view of the headline segment of FIG. 7;

FIG. 10 is a right side elevation view of the headline segment of FIG. 7;

FIG. 11 is a left side elevation view of the headline segment of FIG. 7;

FIG. 12 is a perspective view of a central headline segment in accordance with one embodiment;

FIG. 13 is a perspective view of an end headline segment in accordance with one embodiment;

FIG. 14 is a perspective view of a headline or footrope segment in accordance with one embodiment;

FIG. 15 is another perspective view of the segment of FIG. 14;

FIG. 16 is a top plan view of the segment of FIG. 14;

FIG. 17 is a right side elevation view of the segment of FIG. 14;

FIG. 18 is a left side elevation view of the segment of FIG. 14;

FIG. 19 is a top plan view of the segment of FIG. 14 with a first incidence angle;

FIG. 20 is a top plan view of the segment of FIG. 14 with a second incidence angle;

FIG. 21 is a is a top plan view of a headline in accordance with one embodiment;

FIG. 22 is a top plan view of a headline in accordance with one embodiment;

FIG. 23 is a perspective view of a headline or footrope segment in accordance with one embodiment.

FIG. 24 is another perspective view of the segment of FIG. 23;

FIG. 25 is a top plan view of the segment of FIG. 23;

FIG. 26 is a right side elevation view of the segment of FIG. 23;

FIG. 27 is a left side elevation view of the segment of FIG. 23;

FIG. 28 is a top plan view of a headline in accordance with one embodiment;

FIG. 29 is a perspective view of a trawl net system in accordance with another embodiment;

FIG. 30 is a partial perspective view of the trawl net system of FIG. 29;

FIG. 31 is a partial perspective view of a plurality of segments of the trawl net system of FIG. 29;

FIG. 32 is a perspective view of a segment in accordance with another embodiment;

FIG. 33 is a front view of the segment of FIG. 32;

FIG. 34 is a rear view of the segment of FIG. 32;

FIG. 35 is a side view of an inner side of the segment of FIG. 32;

FIG. 36 is a side view of an outer side of the segment of FIG. 32;

FIG. 37 is a side view of the segment of FIG. 35 with cables attached thereto;

FIG. 38 is a side view of the segment of FIG. 36 with cables attached thereto;

FIG. 39 is a top view of the segment of FIG. 32;

FIG. 40 is a perspective cut-away view of the segment of FIG. 32 taken along the line 40-40 in FIG. 35;

FIG. 41 is a cross-sectional view of the segment of FIG. 32 taken along the line 40-40 in FIG. 35;

FIG. 42 is a computational fluid dynamic diagram of a plurality of segments;

FIG. 43 is a perspective view of a trawl net system in accordance with another embodiment;

FIG. 44 is a partial perspective view of the trawl net system of FIG. 43; and

FIGS. 45 and 46 are perspective views of a plurality of segments of the trawl net system of FIG. 43.

The drawings included herewith are for illustrating various examples of articles, methods, and apparatuses of the teaching of the present specification and are not intended to limit the scope of what is taught in any way.

### DESCRIPTION OF EXAMPLE EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

While the apparatus and methods disclosed herein are described specifically in relation to and in use with trawl net, it will be appreciated that the apparatus and methods may alternatively be used with other types of underwater towed systems.

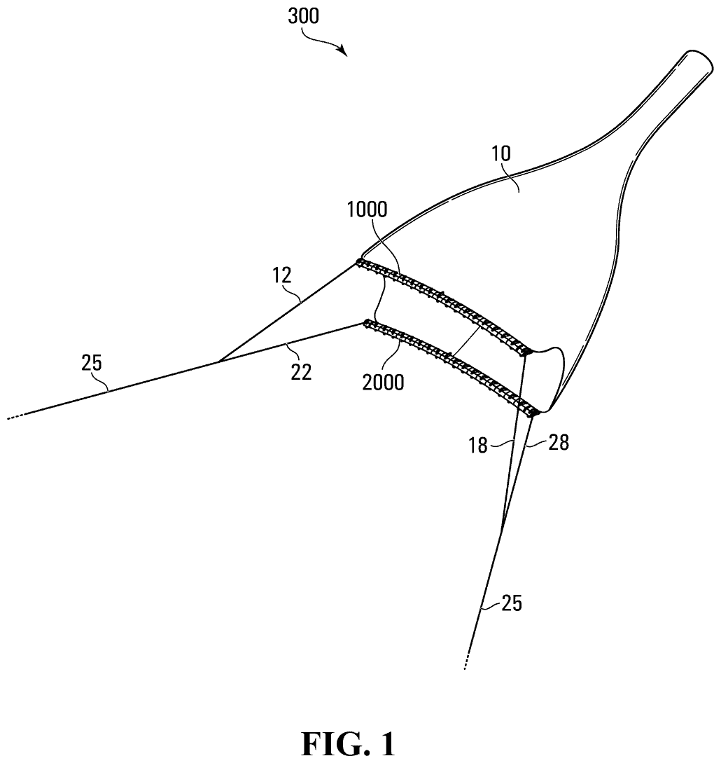

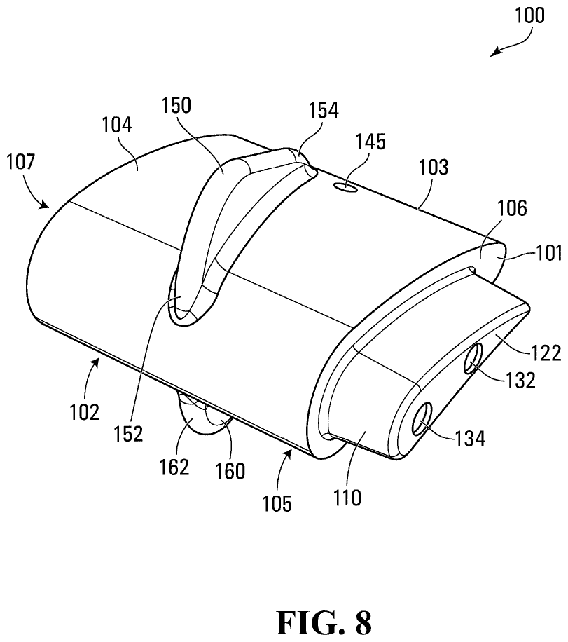

FIGS. 1-13 illustrate an example embodiment of a trawl net system, referred to generally as 300. With reference to FIG. 1, trawl net system 300 includes a headline 1000, a footrope 2000, and a trawl net 10. Trawl net system 300 also includes headline cables 12, 18 and footrope cables 22, 28. Trawl net system 300 is configured to be pulled through a body of water by one or more surface vessels, e.g., using tow cables 25.

Notably, the trawl net system 300 illustrated in FIG. 1 does not include trawl doors, which are typically provided in order to hold the net 10 open as the trawl is pulled through a body of water. Providing a trawl net system that does not require trawl doors may have one or more advantages. For example, the absence of trawl doors may reduce the overall drag force required to pull the trawl net through the body of water, which may reduce fuel usage by the vessel(s) towing the trawl net. Additionally, or alternatively, an absence of trawl doors may increase safety aboard towing vessels. For example, launching and/or retrieving trawl doors may involve greater risks to crew safety as compared to systems and methods disclosed herein. Additionally, or alternatively, an absence of trawl doors may reduce the impact on the seabed.

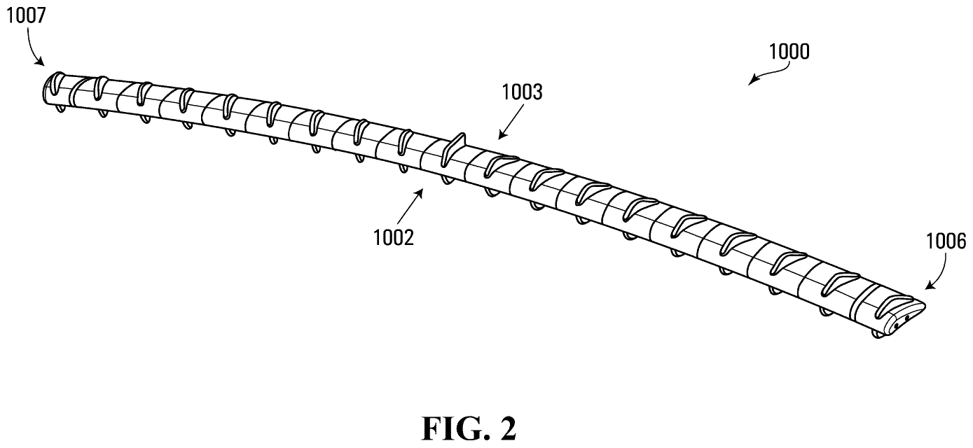

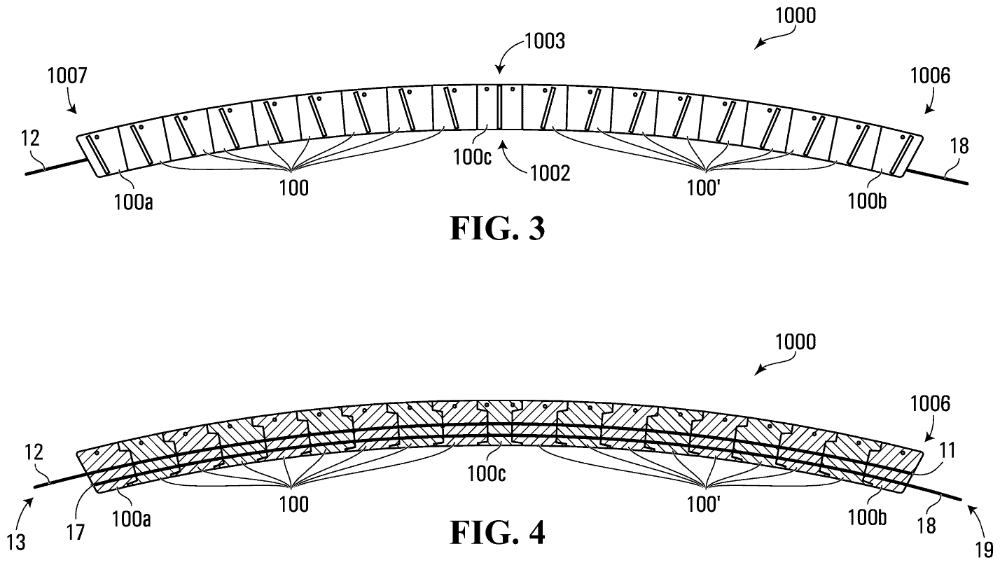

With reference to FIGS. 2 to 6, headline 1000 has a first end 1006, a second end 1007, a leading edge 1002, and a trailing edge 1003. In the illustrated example, the leading edge 1002 of headline 1000 has an arcuate profile when viewed from above, e.g., as shown in FIG. 3, with portions of the leading edge 1002 proximate the first and second ends 1006, 1007 being located forward of a central portion of leading edge 1002. Providing an arcuate headline may have one or more advantages. For example, an arcuate headline may have greater rigidity when being towed than a substantially linear headline.

Headline 1000 is formed of a plurality of headline segments 100 that, when interlocked as shown in FIGS. 2 to 4, form a substantially rigid headline. In the illustrated example, headline 1000 includes a central headline segment 100c, first end headline segment 100a, eight headline segments 100 positioned between central segment 100c and first end segment 100a, second end headline segment 100b, and eight headline segments 100′ positioned between central segment 100c and second end segment 100b. Preferably, headline segments 100 and headline segments 100′ are substantially mirror images of each other. It will be appreciated that more than eight headline segments 100 and/or 100′ may be provided in one or more alternative embodiments. For example, the number of headline segments 100 and/or 100′ may be selected based on e.g., the size and/or engine power of the vessel(s) that will be used to tow the headline. Additionally, or alternatively, the number of headline segments 100 and/or 100′ may be selected based on the size of the area to be fished using the trawl net. It will also be appreciated that fewer than eight headline segments 100 and/or 100′ may be provided in one or more alternative embodiments.

In one or more alternative embodiments, headline 1000 may not include a central headline segment 100c and/or end headline segments 100a, 100b. For example, a headline 1000 may consist of a plurality of headline segments 100 (or headline segments 100′). An advantage of such a design is that each headline segment 100 (or 100′) may be interchangeable with any other headline segment 100 (or 100′), which may facilitate assembly and/or repair of headline 1000.

With reference to FIGS. 3 to 6, in the illustrated example a first headline cable 12 is secured at one end 11 to headline segment 100b, and extends through a first transverse bore of each of the plurality of headline segments. A second headline cable 18 is secured at one end 17 to headline segment 100a, and extends through a second transverse bore of each of the plurality of headline segments.

In use, when the headline cables 12 and 18 are towed through a body of water by their other ends 13 and 19, tension from the headline cables 12 and 18, and/or pressure exerted on headline segments 100 as they are dragged through the body of water urges adjacent headline segments into mutual engagement with each other to form a substantially rigid headline 1000.

Also, when the headline 1000 is no longer towed (e.g., when the trawling vessel(s) have slowed or stopped), pressure exerted by the water flow will be reduced and tension may be lessened or removed from headline cables 12 and 18, which may allow the headline segments 100 to disengage and separate from each other. This may facilitate the net system 300 being brought to the surface.

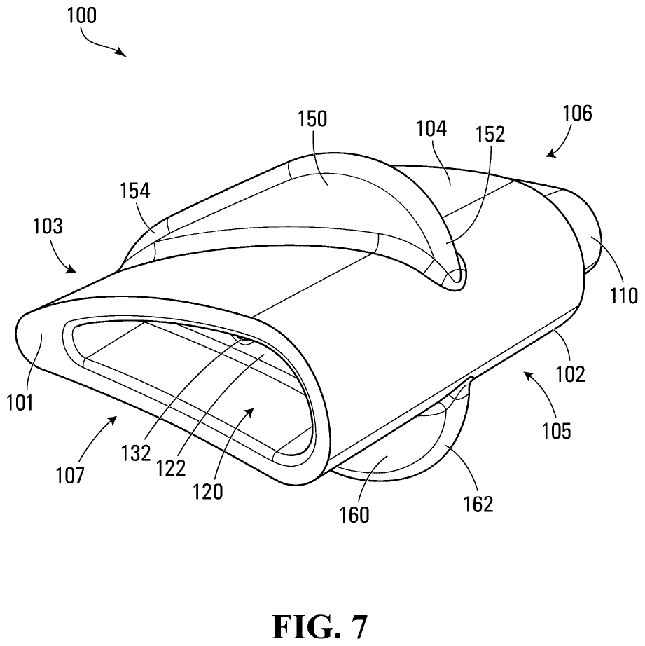

Turning to FIGS. 7 to 11, an example of a headline segment 100 is illustrated in greater detail. Headline segment 100 includes a segment body 101 having a leading edge 102, a trailing edge 103, an upper surface 104, a lower surface 105, a first side 106, and a second side 107. An engagement projection 110 extends outwardly from the first side 106, and an engagement recess 120 extends inwardly from the second side 107.

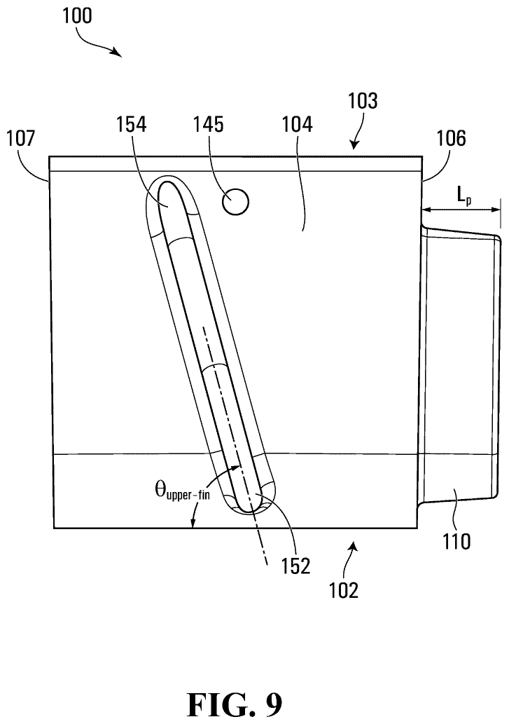

With reference to FIG. 9, engagement projection 110 extends outwardly from first side 106 by a length L_{P}. Preferably, projection length L_{P} is substantially equal to a depth of engagement recess 120, such that when an engagement projection 110 is positioned within an engagement recess 120 of an adjacent headline segment, the first side 106 and second side 107 of the adjacent headline segments abut each other, and an outer surface 112 of engagement projection 110 is in abutment with an inner surface 122 of the engagement recess 120 in which projection 110 is positioned.

With reference to FIG. 9, in the illustrated example the first side 106 and second side 107 of headline segment 100 are not parallel. Put another way, the first and second sides 106, 107 are closer to each other proximate leading edge 102 than they are proximate trailing edge 103. This configuration may promote the arcuate profile of headline 1000 illustrated in FIGS. 2 and 3.

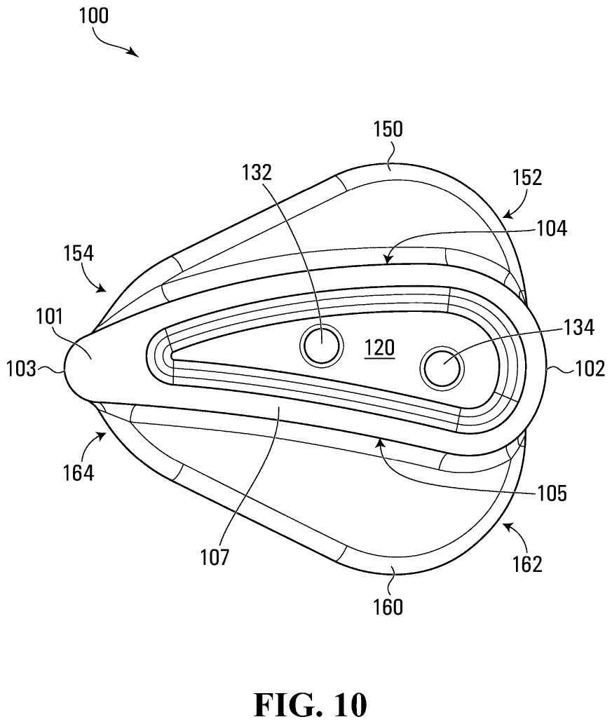

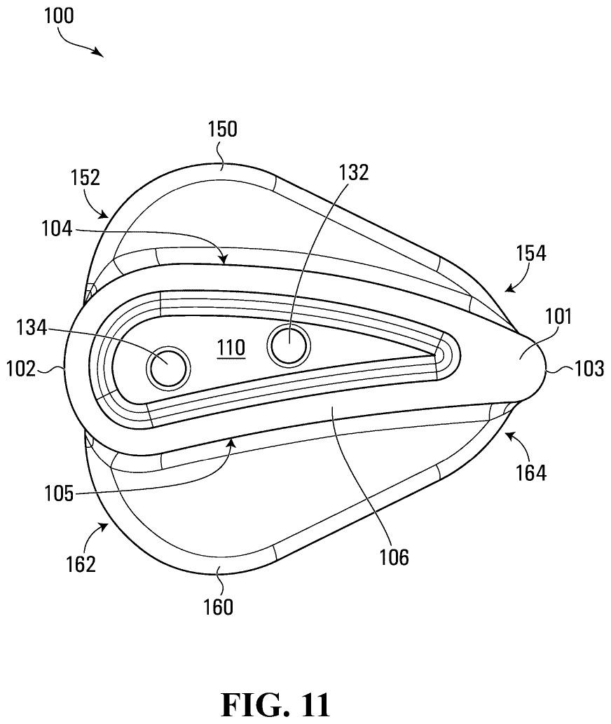

Turning to FIGS. 10 and 11, in the illustrated example a first transverse bore 132 extends through the segment body 101 at a location generally central between the leading edge 102 and the trailing edge 103 of the headline segment 100. A second transverse bore 134 extends through the segment body 101 at a location generally central between the leading edge 102 and the first transverse bore 132. It will be appreciated that bore 132 and/or bore 134 may be provided in other suitable locations in one or more alternative embodiments.

With continuing reference to FIGS. 10 and 11, in the illustrated example the segment body 101 is generally hydrofoil-shaped when viewed from the side. An advantage of this design is that each segment may configured to exert an upwards ‘lift’ or force when fluid passes along the segment from the leading edge 102 towards the trailing edge 103. This ‘lift’ may assist in holding the net 10 open when the trawl net system 300 is towed through a body of water.

In the illustrated example, the engagement projection 110 is generally hydrofoil-shaped when viewed from the side, and has a similar profile shape to that of the segment body 101. An advantage of this design is that it may facilitate alignment of the projection 110 with a recess 120 of an adjacent headline segment as the segments begin to be towed through a body of water.

Returning to FIG. 9, in the illustrated example a securement bore 145 extends through the segment body 101 from the upper surface 104 to the lower surface 105, and is positioned proximate the trailing edge 103 of the headline segment. Securement bore 145 may be used to secure the trawl net 10 to the headline 1000. In the illustrated example, each headline segment 100 has a single securement bore 145. It will be appreciated that two or more securement bores may be provided on each headline segment 100 in one or more alternative embodiments. Alternatively, one or more headline segments 100 in a headline 1000 may not have a securement bore.

With reference to FIGS. 2, 3, and 7 to 11, in the illustrated example each headline segment has an optional upper alignment fin. For example, as illustrated in FIGS. 7 to 11, an upper alignment fin 150 extends upwardly from the upper surface 104 of the headline segment 100. A leading end 152 of upper alignment fin 150 is located proximate the leading edge 102 of headline segment 100, and a trailing end 154 of upper alignment fin 150 is located proximate the trailing edge 103.

As perhaps best seen in FIG. 9, in the illustrated example upper alignment fin 150 is positioned at an angle θ_{Upper_fin} to the leading edge 102 of the headline segment 100. Preferably, the angle θ_{Upper_fin} is between about 65° and 85°, and more preferably the angle θ_{Upper_fin} is about 75°.

Also, in the illustrated example each headline segment has an optional lower alignment fin. For example, as illustrated in FIGS. 7 to 11, a lower alignment fin 160 extends downwardly from the lower surface 105 of the headline segment 100. A leading end 162 of lower alignment fin 160 is located proximate the leading edge 102 of headline segment 100, and a trailing end 164 of lower alignment fin 160 is located proximate the trailing edge 103.

In the illustrated example, lower alignment fin 160 is positioned at an angle θ_{Lower_fin} to the leading edge 102 of the headline segment 100. Preferably, the angle θ_{Lower_fin} is between about 65° and 85°, and more preferably the angle θ_{Lower_fin} is about 75°.

While the upper and lower alignment fins 150, 160 are illustrated at the same angle to the leading edge 102 of the headline segment, this need not be the case.

Providing headline segments 100 with upper alignment fins 150 and/or lower alignment fins 160 may have one or more advantages. For example, the alignment fins may provide improved stability to headline 1000 as it is towed through a body of water. Additionally, or alternatively, alignment fins 150 and/or 160 may facilitate engagement between the headline segments of headline 1000 as it begins to be towed through a body of water.

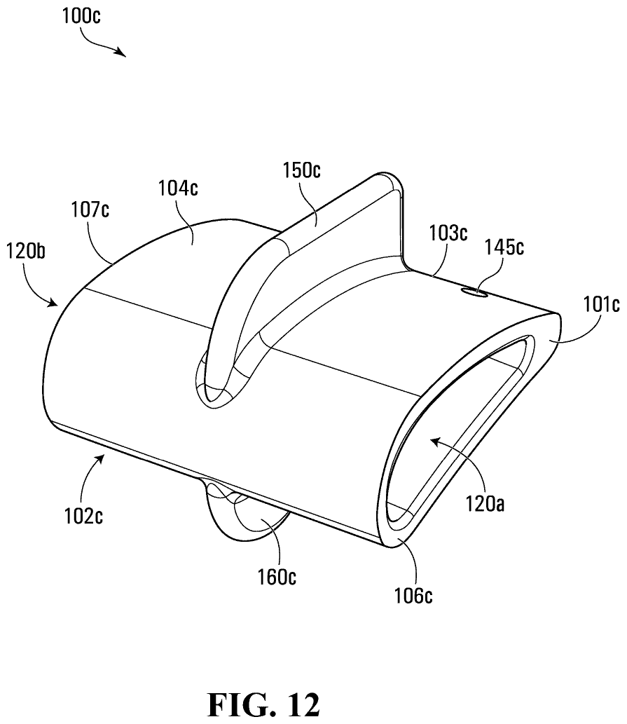

FIG. 12 illustrates an example of a central headline segment 100c. Central headline segment 100c includes a segment body 101c having a leading edge 102c, a trailing edge 103c, an upper surface 104c, a lower surface 105c, a first side 106c, and a second side 107c. A first engagement recess 120a extends inwardly from the first side 106c, and a second engagement recess 120b extends inwardly from the second side 107c.

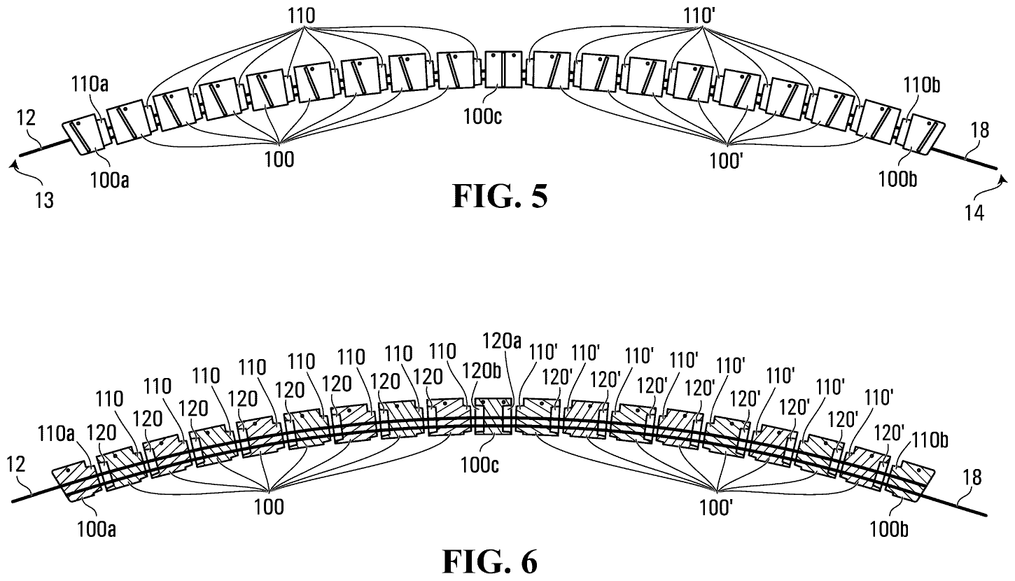

In the illustrated example, central headline segment 100c has an optional upper alignment fin 150c and an optional lower alignment fin 160c. As perhaps best seen in FIGS. 3 and 5, upper and lower alignment fins 150c, 160c are each positioned generally perpendicularly to leading edge 102c of central headline segment 100c (i.e., at an angle of about 90°).

Also, in the illustrated example, two securement bores 145c extend through the central segment body 101c from the upper surface 104c to the lower surface 105c, and are positioned proximate the trailing edge 103c of the central headline segment.

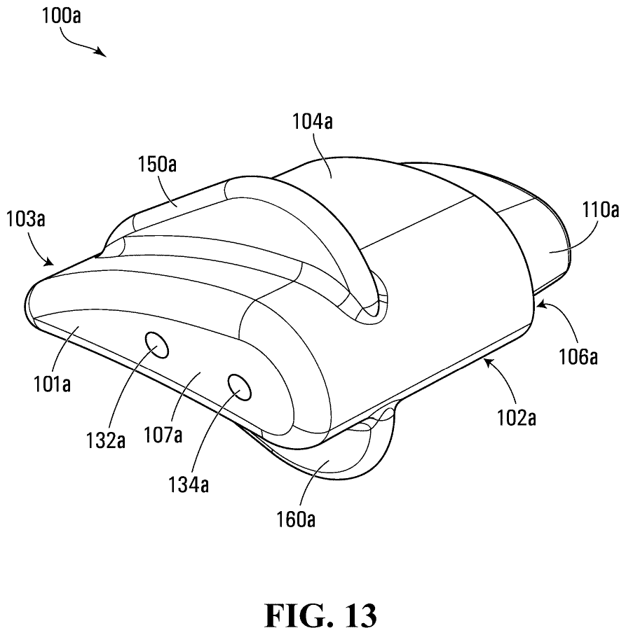

FIG. 13 illustrates an example of an end headline segment 100a. End headline segment 100a includes a segment body 101a having a leading edge 102a, a trailing edge 103a, an upper surface 104a, a lower surface 105a, a first side 106a, and a second side 107a. A first engagement projection 110a extends outwardly from the first side 106a. In the illustrated example, the second side 107a is generally planar. Optionally, one or more surface features (not shown) may be provided on second side 107a to facilitate securement of an end of a headline cable to headline segment 100a.

In the illustrated example, end headline segment 100a has an optional upper alignment fin 150a and an optional lower alignment fin 160a. As perhaps best seen in FIGS. 3 and 5, upper and lower alignment fins 150a, 160a are each positioned at an angle to the leading edge 102a of the end headline segment (e.g., at an angle of between about 65° and 85°, or at an angle of about 75°).

In the illustrated example, a single securement bore 145a extends through the end segment body 101a, and is positioned proximate the trailing edge 103a of the end headline segment.

The segments of headline 1000 (e.g., central headline segment 100c, first and second end headline segments 100a, 100b, and headline segments 100 and 100′) may be made from any suitable material, such as a polymer, a thermoplastic, or a fiber-reinforced polymer. Preferably, the segments of headline 1000 are buoyant in seawater. An advantage of providing buoyant headline segments is that they may tend to raise the upper opening of trawl net 10.

Optionally, the segments of headline 1000 may be made from a biodegradable material. Accordingly, if a segment 100 is lost at sea, it may be more readily degraded over time.

Optionally, one or more segments of headline 1000 may include a light emitting device (not shown), such as a battery-powered light emitting diode (LED) lighting system. Providing one or more lights integrated with headline 1000 may have one or more advantages. For example, the lights may be selectively illuminated to attract desired species of marine life towards the opening of net 10 and/or deter undesired species from entering the net opening.

Optionally, trawl net system 300 may include a footrope that is formed of a plurality of footrope segments that, when interlocked, form a substantially rigid footrope. For example, footrope 2000 may be formed from segments that have a similar design and/or configuration of the segments of headline 1000. Similar to headline 1000, when footrope cables 22 and 28 are towed through a body of water, tension from the footrope cables 22, 28, and/or pressure exerted on the footrope segments as they are dragged through the body of water may urge adjacent footrope segments into mutual engagement with each other to form a substantially rigid footrope 2000.

The segments of footrope 2000 may be made from any suitable material, such as a polymer, a thermoplastic, or a fiber-reinforced polymer. Preferably, the segments of footrope 2000 have a negative buoyancy in seawater. For example, the footrope segments may be formed from a material that has a negative buoyancy (e.g., a polymer embedded with metallic particles). Alternatively, the footrope segments may include one or more weights (not shown) to ensure negative buoyancy. An advantage of providing non-buoyant footrope segments is that they may tend to lower the lower opening of trawl net 10.

Optionally, one or more segments of footrope 2000 may include a light emitting device (not shown), such as a battery-powered light emitting diode (LED) lighting system. Providing one or more lights integrated with footrope 2000 may have one or more advantages. For example, the lights may be selectively illuminated to attract desired species of marine life towards the opening of net 10 and/or deter undesired species from entering the net opening.

Trawl net systems as disclosed herein may have one or more advantages over traditional trawl net systems. For example, trawl net system 300 may be more easily towed above a seabed (i.e., with little or optionally no contact with the seabed), which may reduce the impact on the seabed. In contrast, the ground gear of typical trawl net systems is usually dragged along a seabed, which may cause ecological damage to the seabed and/or increase the risk of snags or other damage to the trawl net.

In one or more alternative embodiments, a segment of the headline or footrope may be hydrodynamically shaped such that the segment is adapted to be urged away from a center point 3013 (shown in FIG. 22) of the cable when the segment is pulled through water by the cable. In other words, the segment may be shaped such that an outward lateral force, also referred to as lateral lift, may act on each segment in a plurality of segments to form a catenary shape of the headline or footrope, thereby assisting in holding the trawl net in an open position when the headline or footrope is towed through a body of water.

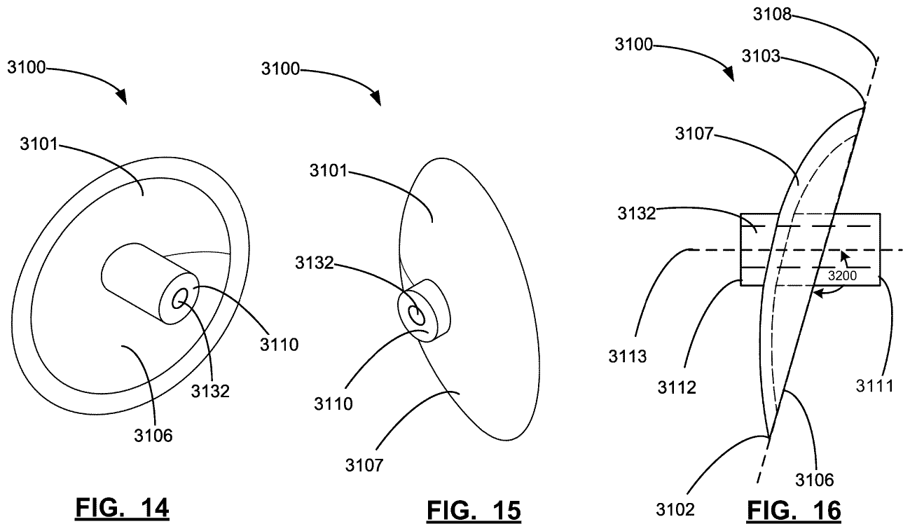

Referring to FIGS. 14-20, illustrated therein is an example embodiment of a segment 3100. For ease of understanding, like elements have been numbered with like reference numbers with an incremented difference. The segment 3100 has a segment body 3101 having a leading edge 3102 (in relation to the direction of movement of the segment 3100 through the water), a trailing edge 3103, an upper portion 3104, a lower portion 3105, an inner side 3106, and an outer side 3107.

As exemplified in FIGS. 14-20, a hub 3110 extends outwardly past each of the inner side 3106 and the outer side 3107. The hub 3110 has a first end 3111 and a second end 3112. The hub 3110 has a transverse bore 3132 extending from the first end 3111 to the second end 3112. The transverse bore 3132 is sized to receive a headline cable 3012 or a footrope cable (not shown). In some embodiments, the bore 3132 may extend through the segment without a hub 3110.

Referring to FIGS. 21 and 22, illustrated therein is an example embodiment of a headline 3000 having of a plurality of segments 3100. The headline 3000 may be formed by passing the headline cable 3012 through each transverse bore 3132 in the plurality of segments 3100. While the illustrated embodiment shows a headline, it will be appreciated that the same or similar design may be used for a footrope.

As illustrated in FIG. 22, when the headline 3000 is pulled through the water by the cable 3012, the hydrodynamic shape of each segment 3100 causes a lateral lift such that the segments 3100 are urged outward from the center point 3013 of the cable 3012. This lateral lift acts on each segment 3100, thereby causing the cable 3012 to form a catenary shape as the cable 3012 is pulled through water. This catenary shape assists with the opening of a trawl net in a trawl net system when the trawl net system is towed through a body of water.

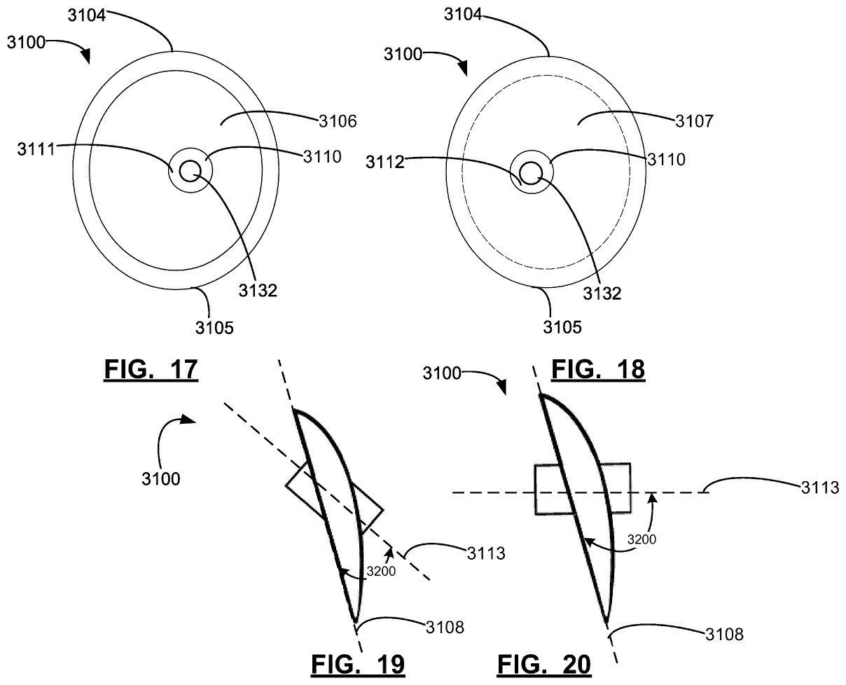

Referring to FIGS. 17 and 18, the hydrodynamic shape of segment body 3101 convexly shaped. As shown, the segment body 3101 is a half-cup, with the inner side 3106 being concave and the outer side 3107 being convex. As shown in FIGS. 21 and 22, the plurality of segments 3100 are mirrored across the center point 3013 of the cable 3012. In other words, the cable 3012 has a first plurality of segments 3100a with the inner side 3106 facing a first direction and a second plurality of segments 3100b with the inner side 3106 facing a second direction, opposite the first direction. When the plurality of segments 3100 is towed through the water by the cable 3012, the flow of water acts on the inner side 3106 of each segment 3100, thereby increasing a drag force on the segments 3100. Due to the shape of the segment bodies 3101, the drag force operates to produce lateral lift of each segment 3100, thereby urging the segments 3100 to move laterally outward from the center point 3013 of the cable 3012. Since the segments 3100 are mirrored across the centerline of the cable 3012, the lateral lift is applied outwardly from the center point 3013 of the cable 3012 in both directions.

Referring to FIG. 22, as shown, each segment 3100 is fixed in position on the cable 3012. In some embodiments, the segments 3100 may be movable along the cable 3012. In some embodiments, some of the segments 3100 may be fixed in position on the cable 3012 while other segments 3100 are movable along the cable 3012.

Referring to FIGS. 16, 19, and 20, the hub 3110 has a hub longitudinal axis 3113 extending from the first end 3111 to the second end 3112 and the segment body 3101 has a segment longitudinal axis 3108 extending from the leading edge 3102 to the trailing edge 3103. The hub longitudinal axis 3113 and the segment longitudinal axis 3108 together form an incidence angle 3200, as illustrated in FIG. 19. The incidence angle 3200 may vary depending on the desired use of the segment 3100. For example, the incidence angle 3200 may be chosen based on the natural catenary shape of the cable 3012 when the cable 3012 is pulled through water. This natural catenary shape may vary depending on the type of net used in the trawl net system.

The incidence angle 3200 may be based on a slope of a portion of the catenary shape of the cable 3012. The incidence angle 3200 may be the same for each segment 310, as shown in FIGS. 21 and 22, or may be different. For example, referring to FIG. 22, the first plurality of segments 3100a are bunched proximate a first region 3014 of the cable 3012 and the second plurality of segments 3100b are bunched proximate a second region 3015 of the cable 3012.

As shown in FIG. 22, the absolute value of the slope of the cable 3012 at each position of each segment 3100 is approximately the same. Accordingly, the incidence angle 200 for each segment in the first plurality of segments 3100a and each segment in the second plurality of segments 3100b is approximately the same. An advantage of this design is that the segments 3100 for region 3014 may be manufactured to have the same incidence angle 3200 and the segments 3100 for region 3015 may be manufactured to have the same incidence angle 3200, thereby simplifying the manufacturing process.

Alternatively, or in addition, the incidence angle 3200 of one or more segments 3100 may vary based on the slope of the natural catenary shape of the cable 3012, as the cable 3012 moves through water. By varying the incidence angle 3200 of each segment 3100 based on the catenary shape of the cable 3012, when moving through water, the lateral lift may be optimized for each segment, thereby improving the operation of the trawl net system. For example, as shown in FIG. 22, the slope of the cable 3012 decreases from the region 3014 to the center point 3013. Accordingly, the incidence angle 3200 may be varied to accommodate the change in slope at each portion of the cable 3012 that receives segment 3100. In other words, the incidence angle 3200 of segment 3100 may increase at an inversely proportional rate to the change in slope of the cable 3012.

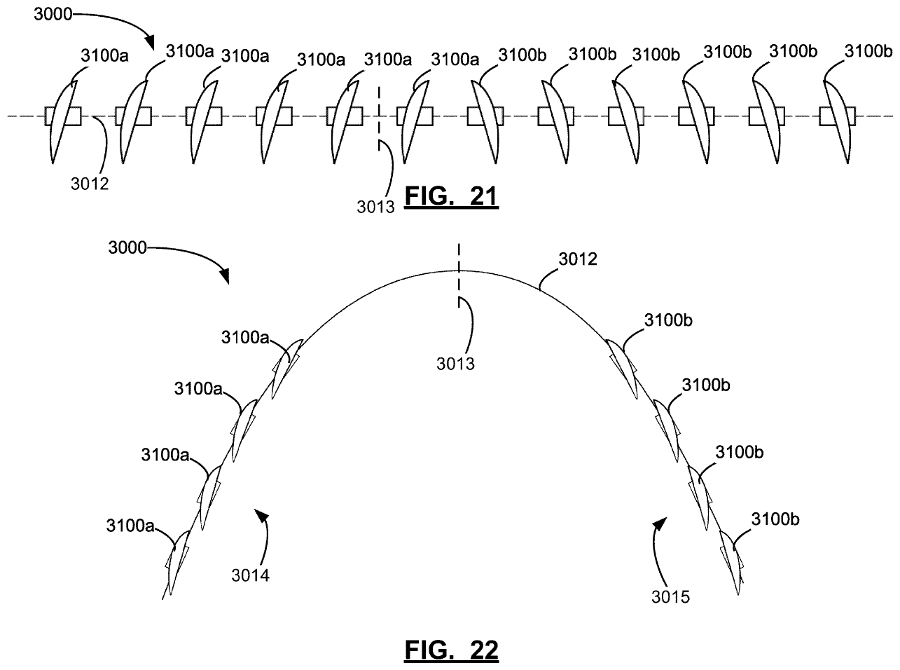

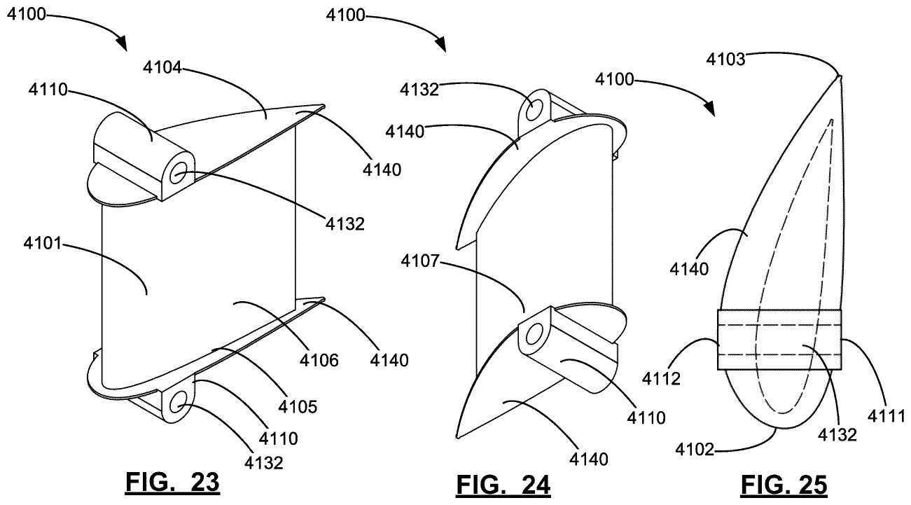

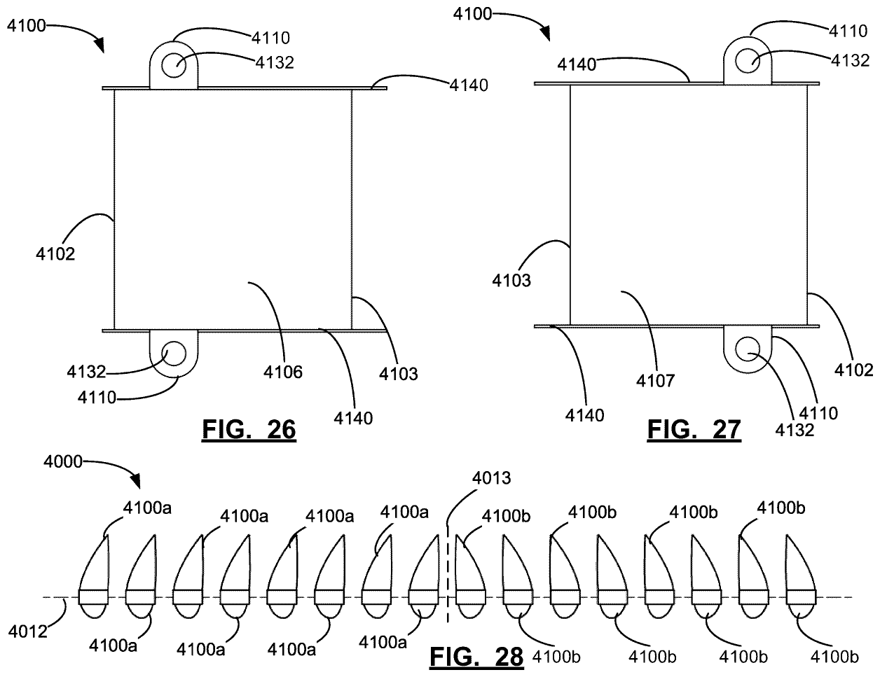

Referring to FIGS. 23-27, illustrated therein is an example embodiment of a segment 4100. For ease of understanding, like elements have been numbered with like reference numbers with an incremented difference. The segment 4100 has a segment body 4101 having a leading edge 4102 (in relation to the direction of movement of the segment 4100 through the water), a trailing edge 4103, an upper portion 4104, a lower portion 4105, an inner side 4106, and an outer side 4107.

A first hub 4110 and a second hub 4110, together referred to as hubs 4110, extend outwardly past each of the inner side 4106 and the outer side 4107. The hubs 4110 each have a first end 4111 and a second end 4112. The hubs 4110 each have a transverse bore 4132 extending from the first end 4111 to the second end 4112. The transverse bore 4132 is sized to receive a headline cable 4012 or a footrope cable (not shown).

As shown, the first hub 4110 is positioned proximate the upper portion 4104 and the second hub 4110 is positioned proximate the lower portion 4105. An advantage of this design is that the hubs 4110 may be separated from the rest of the segment body 4101, thereby maintaining the hydrodynamic shape of the segment body 4101. In other words, the hubs 4110 are spaced apart from the surfaces of the segment body 4101 that operate as lifting surfaces.

Referring to FIG. 28, illustrated therein is an example embodiment of a headline 4000 having of a plurality of segments 4100. The headline 4000 may be formed by passing the headline cables 4012 through each transverse bore 4132 in the plurality of segments 4100. While the illustrated embodiment shows a headline, it will be appreciated that the same or similar design may be used for a footrope.

Each hub 4110 may receive a respective cable 4012 for forming the headline or footrope. The presence of two cables 4012 may improve the operation of the trawl net system by improving the ability of the segment 4100 to maintain proper alignment with the water flow as the segment 4100 is towed through water.

In the illustrated example, the hydrodynamic shape of segment body 4101 is foil-shaped. When the plurality of segments 4100 is towed through the water by the cable 4012 the flow of water passes over the segment body 4101 produces a lift force on the segments 4100. In other words, when towed through water, a high pressure region is created proximate the inner side 4106 and a low pressure region is created proximate the outer side 4107. This pressure differential creates the lateral lift of each segment 4100, thereby urging the segments 4100 to move laterally outward from the center point 4013 of the cable 4012.

As shown in FIG. 28, the plurality of segments 4100 are mirrored across the centerline 4013 of the cable 4012. In other words, the cable 4012 has a first plurality of segments 4100a with the inner side 4106 facing a first direction and a second plurality of segments 4100b with the inner side 4106 facing a second direction, opposite the first direction. Since the segments 4100 are mirrored across the center point 4013 of the cable 4012, the lateral lift is applied outwardly from the center point 4013 of the cable 4012 in both directions.

In the illustrated embodiment, the segment 4100 has a first endplate 4140 and a second endplate 4140, together referred to as endplates 4140. As shown, an endplate 4140 is positioned proximate the upper portion 4104 and the lower portion 4105. The endplates 4140 may limit 3D losses of the segment 4100, thereby improving the hydrodynamics of the segment body 4101.

In one or more embodiments, the trawl net system may include segments that are positionable on one or more bridles. Positioning segments on the bridles may improve the efficiency of the trawl net system. Each segment produces a lateral lift and a drag force when it is pulled through water. The drag force may, in some cases, close the trawl net, reducing the efficiency of the net. By distributing the segments along the bridles, the lateral lift force operating on the segments may be utilized while reducing the impact of the drag force.

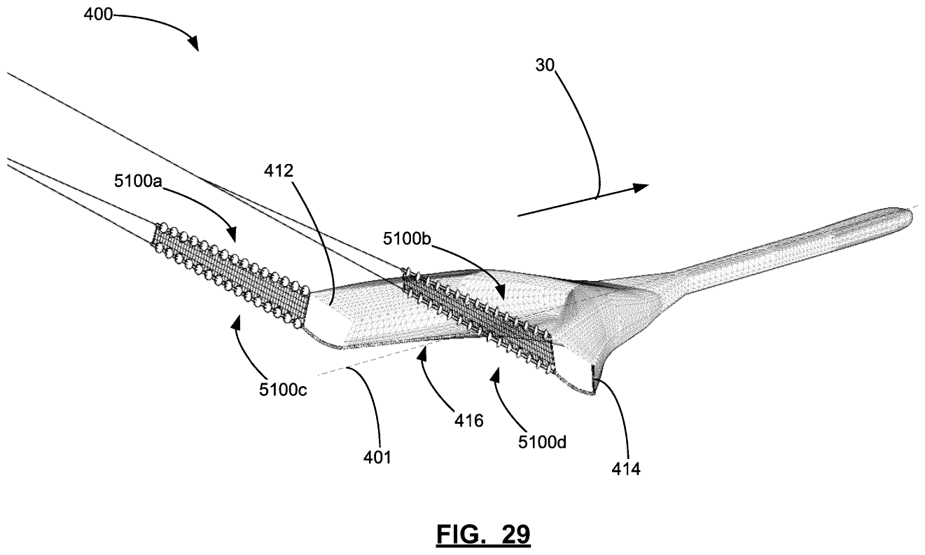

Referring to FIG. 29, illustrated therein is a trawl net system 400 that has a net 410 with a first lateral side 412, a second lateral side 414, and an opening 416 therebetween. As shown, the trawl net system 400 has a longitudinal axis 401. The longitudinal axis 401 may extend generally parallel to a flow direction of water 30 when the trawl net system 400 is pulled through the water.

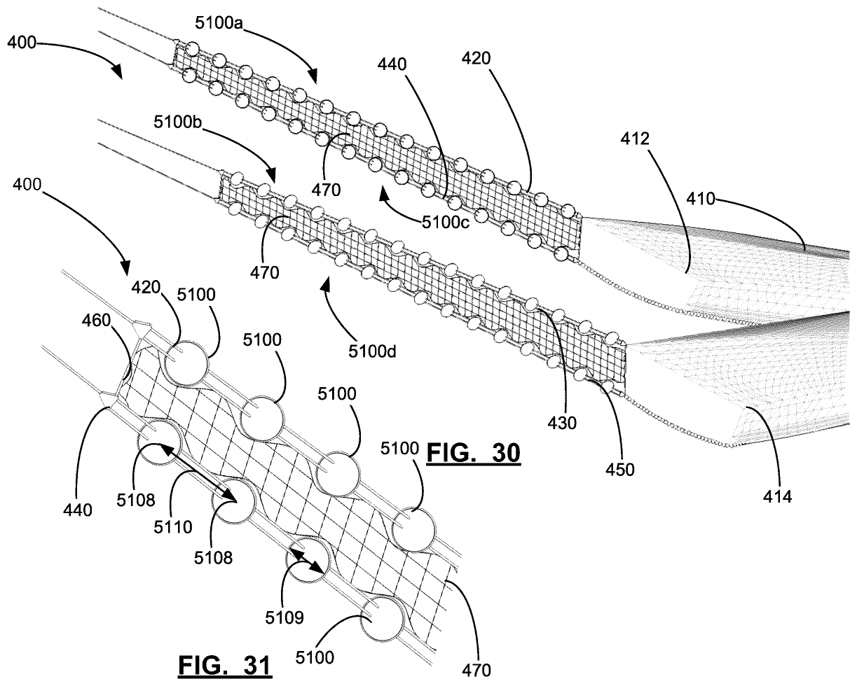

The trawl net system 400 may be pulled through water by one or more bridles or by one or more cables coupled to the bridles. In some embodiments, the trawl net system 400 may have a plurality of bridles on either lateral side. For example, the trawl net system 400 may have two bridles, one on either lateral side 412 and 414. In the illustrated embodiment, FIG. 30 shows the trawl net system 400 having a first bridle 420, a second bridle 430, a third bridle 440, and a fourth bridle 450. The first bridle 420 and the third bridle 440 are adapted to be coupled to the first lateral side 412 and the second bridle 430 and the fourth bridle 450 are adapted to be coupled to the second lateral side 414.

As illustrated, each bridle is formed of at least one cable. In some embodiments, the first bridle 420 and the third bridle 440 may be formed of the same cable that passes through the first lateral side 412. Similarly, the second bridle 430 and the fourth bridle 450 may be formed of the same cable that passes through the second lateral side 414. Alternately, or in addition, one or more bridles may be formed of independent cables that are separately couplable to the trawl net 410. As shown in FIGS. 30 and 31, for example, each bridle may be formed of a plurality of cables.

In some embodiments, two or more bridles may be coupled together. For example, as shown in FIG. 31, the first bridle 420 and the third bridle 440 are coupled together by a connecting cable 460. As shown in FIG. 30, the second bridle 430 and the fourth bridle 450 are coupled together by a connecting cable 460. The connecting cable 460 may improve the stability of the trawl net system 400.

In some embodiments, the bridles on each lateral side may include a side net 470 extending therebetween. For example, referring to FIGS. 30 and 31, the first bridle 420 and the third bridle 440 include a side net 470 extending therebetween and the second bridle 430 and the fourth bridle 450 include another side net 470 extending therebetween. The side net 470 may improve the efficiency of the trawl net system 400 by assisting with guiding fish to the opening 416.

The side net 470 may assist in maintaining the proper orientation of one or more segments 5100. For example, the side net 470 may be tensioned between the first bridle 420 and the third bridle 440. Segments 5100 on the first bridle 420 may provide a buoyant force while segments 5100 on the third bridle 440 may provide a negative buoyant force, thereby tensioning the side net 470. The tension applied to the side net 470 may assist in maintaining the orientation of the segments 5100.

Each bridle may receive a plurality of segments 5100 that are adapted to control the hydrodynamic movement of the trawl net system 400 when the system is pulled through water by the bridles. For example, as shown in FIG. 29, a first plurality of segments 5100a is positionable on the first bridle 420, a second plurality of segments 5100b is positionable on the second bridle 430, a third plurality of segments 5100c is positionable on the third bridle 440, and a fourth plurality of segments 5100d is positionable on the fourth bridle 450. There may be any number of segments in each of the plurality of segments. The segments 5100 in each plurality of segments may be the same size and shape or may be different.

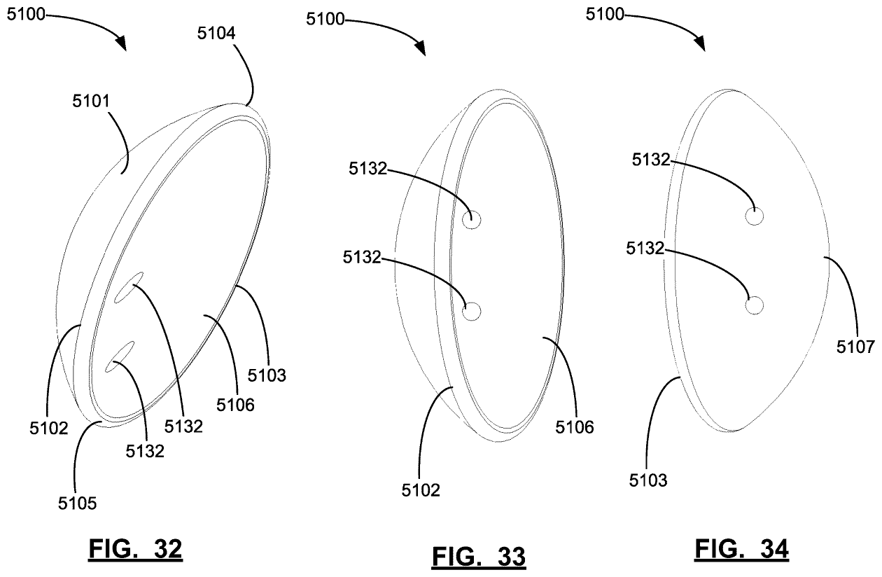

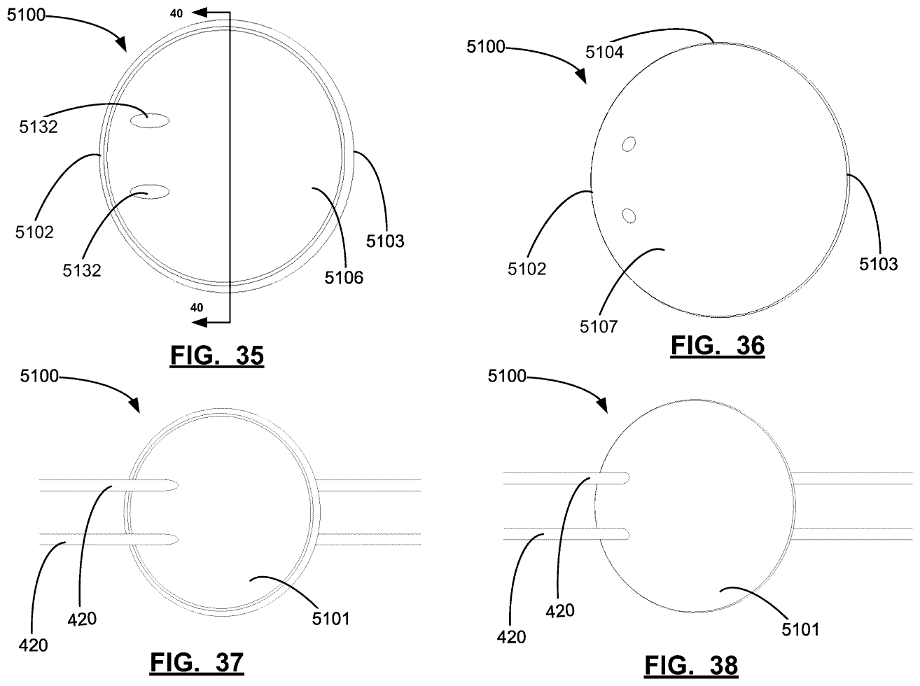

Referring to FIGS. 32-34, as illustrated, each segment 5100 may have a segment body 5101 having a leading edge 5102, a trailing edge 5103, an upper surface 5104, a lower surface 5105, an inner side 5106, and an outer side 5107.

The segment 5100 has at least one passage 5132 extending from the inner side 5106 to the outer side 5107 for receiving a cable from the trawl net system 400. For example, as shown in FIG. 31, each passage 5132 in the first plurality of segments 5100a receives the first bridle 420 and each passage 5132 in the third plurality of segments 5100c receives the third bridle 440.

In some embodiments, the segment body 5101 may have a plurality of passages 5132 for receiving a plurality of cables of the trawl net system 400. For example, referring to FIGS. 30 and 31, each bridle in the trawl net system 400 includes two cables. Each segment 5100 in each plurality of segments 5100a-d has two passages 5132 for receiving the cables of the bridles. As shown, the first passage 5132 is proximate the upper surface 5104 and the second passage 5132 is positioned proximate the lower surface 5105. This design may improve the stability of the segments 5100 as they are pulled through water by restraining the segments from rolling. Reducing the likelihood of rolling may improve the performance of the segments 5100 as they are pulled through the water, maintaining a more consistent angle of incidence relative to the direction of flow 30.

The segment body 5101 may be any shape and/or size that enables the trawl net system 400 to remain open as it is pulled through water. The segment body 5101 is hydrodynamically shaped such that the segment 5100 is adapted to be urged away from the longitudinal axis 401 when the segment 5100 is pulled through water by a cable of the trawl net system 400.

The segment body 5101 may be shaped such that when the segment 5100 is pulled through water, the inner side 5106 forms a high pressure region and the outer side 5107 forms a lower pressure region. A pressure gradient between the inner side 5106 and the outer side 5107 may generate a lateral lift force that urges the segment 5100 in a direction away from the longitudinal axis 401. For example, as shown in FIGS. 32 to 34, the segment body 5101 is shaped as a spherical dome. In other words, the inner side 5106 may be generally planar and the outer side 5107 of the segment body may be generally convex. A convex outer side 5107 may accelerate the flow of water locally, which leads to the lower pressure zone on the outer side 5107, as described above.

In a trawl net system that is generally symmetrical, as exemplified in FIG. 29, the plurality of segments on either side of the longitudinal axis 401 may be urged away from each other. In other words, each segment in the first plurality of segments 5100a and each segment in the second plurality of segments 5100b is hydrodynamically shaped such that they are adapted to be urged away from each other when the segments are pulled through water by the bridles. Similarly, each segment in the third plurality of segments 5100c and each segment in the fourth plurality of segments 5100d is hydrodynamically shaped such that they are adapted to be urged away from each other when the segments are pulled through water by the bridles.

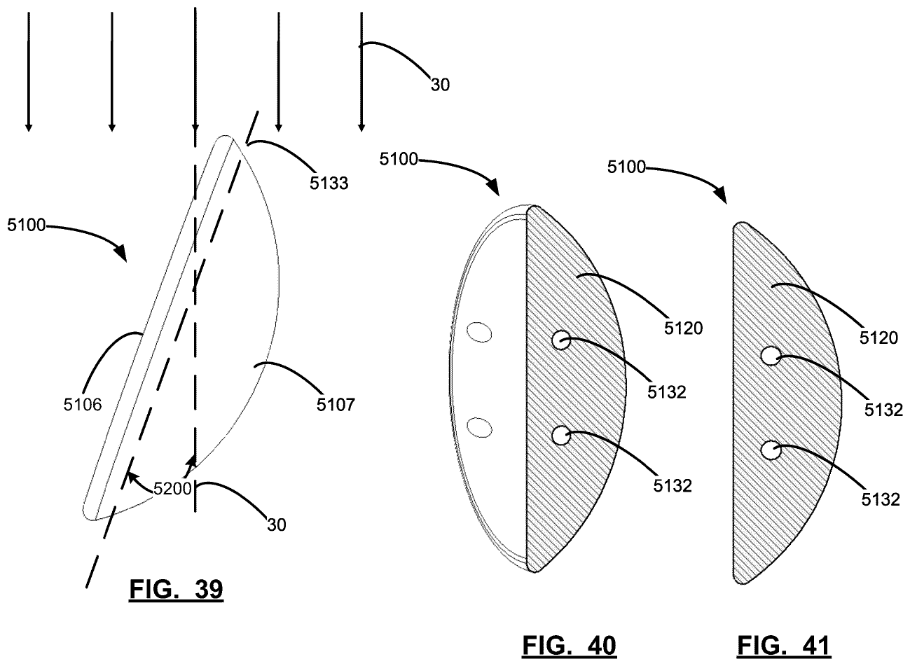

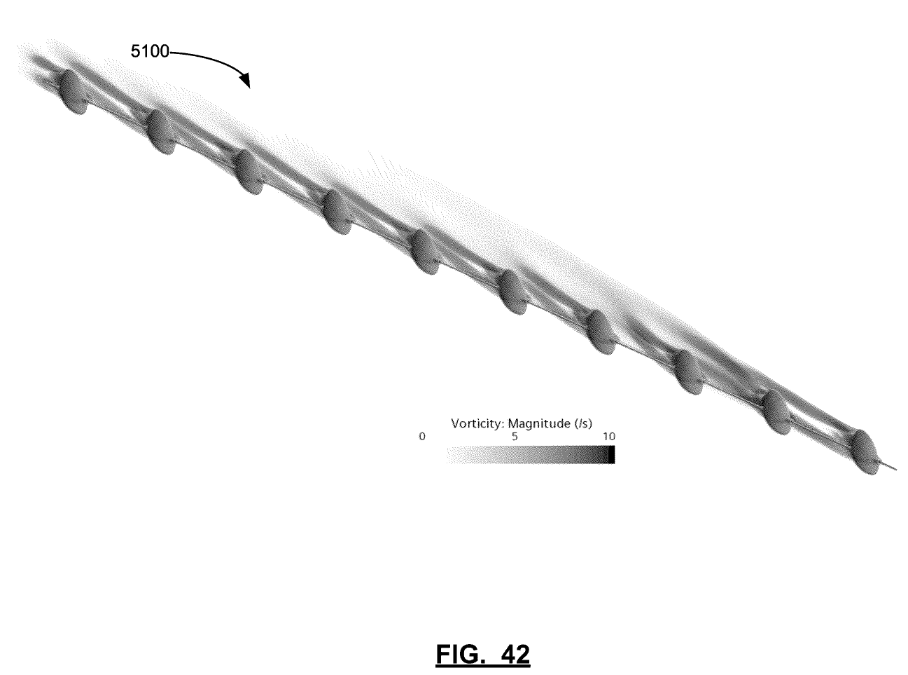

Referring to FIG. 39, as illustrated, water moves along a flow direction 30 when the segment 5100 is pulled through water. The passage 5132 has a longitudinal axis 5133 that extends through the passage 5132. An incidence angle 5200 is formed between the passage longitudinal axis 5133 and the flow direction 30. The incidence angle 5200 may be designed based on a ratio of lateral lift force to drag force acting on the segment 5100 when the segment is pulled through water. The incidence angle may be any angle. For example, the incidence angle 5200 may be in the range of about 0 to about 30 degrees, optionally in the range of about 5 to about 30 degrees. The ratio of lateral lift force to drag force may be greater than about 1, optionally greater than about 1.5, or optionally greater than about 2.5. For example, an incidence angle of about 30 degrees may produce a ratio of lateral lift force to drag force of about 1.5. Increasing the incidence angle above 30 degrees may reduce the ratio below 1.5, while decreasing the incidence angle below 30 degrees may increase the ratio above 1.5. For example, an angle of about 40 degrees may produce a ratio of lateral lift force to drag force of about 1.2. As described previously, the incidence angle 5200 may vary depending on the desired use of the trawl net system 400.

A spherical dome shaped segment 5100 may also provide for a larger interior volume 5120 than if the inner side 5106 were concave. A larger interior volume 5120 may allow for greater control over the buoyancy and/or weight of the segment 5100, thereby improving the operation of the trawl net system 400. Additionally, an asymmetrically shaped segment 5100, such as the segment 5100 shown in FIGS. 32 to 34, may allow for the generation of lateral lift even when the incidence angle 5200 is 0. This lateral lift is caused by the effective camber that results from the asymmetric shape.

The placement of the segments 5100 on their respective bridle may vary depending on the desired use of the trawl net system 400. For example, the segments 5100 may be evenly spaced apart from one another or may vary in their relative positions on the bridle. Referring to FIG. 31, each segment 5100 has a center point 5108 and a length 5109 extending from the leading edge 5102 to the trailing edge 5103. As shown, the segments 5100 are distributed along the bridle by an inter-segment distance 5110. The inter-segment distance 5110 may vary with the size, shape, and/or type of trawl net system. The inter-segment distance 5110 may be chosen such that shielding between adjacent segments is reduced.

The spacing may be, including, but not limited to, greater than one length, greater than two lengths, or any spacing that reduces shielding between adjacent segments. As shown in FIG. 42, for example, the segments are spaced apart with an inter-segment distance greater than two lengths. For example, the segments 5100 may be spaced apart with an inter-segment distance 5110 of three lengths. As shown by the vorticity field, the segments are far enough apart that the shielding impact on the vorticity magnitude is reduced. In other words, as the segments 5100 are pulled through the water, the lead segment will produce drag and a vorticity field. By spacing the next segment 5100 three segment lengths away from the lead segment, the impact on the vorticity field of the second segment may be reduced, thereby improving the efficiency of the trawl net system 400. This inter-segment distance may allow for each segment 5100 to have sufficient contact with water to produce the desired lateral lift to maintain the trawl net opening 416.

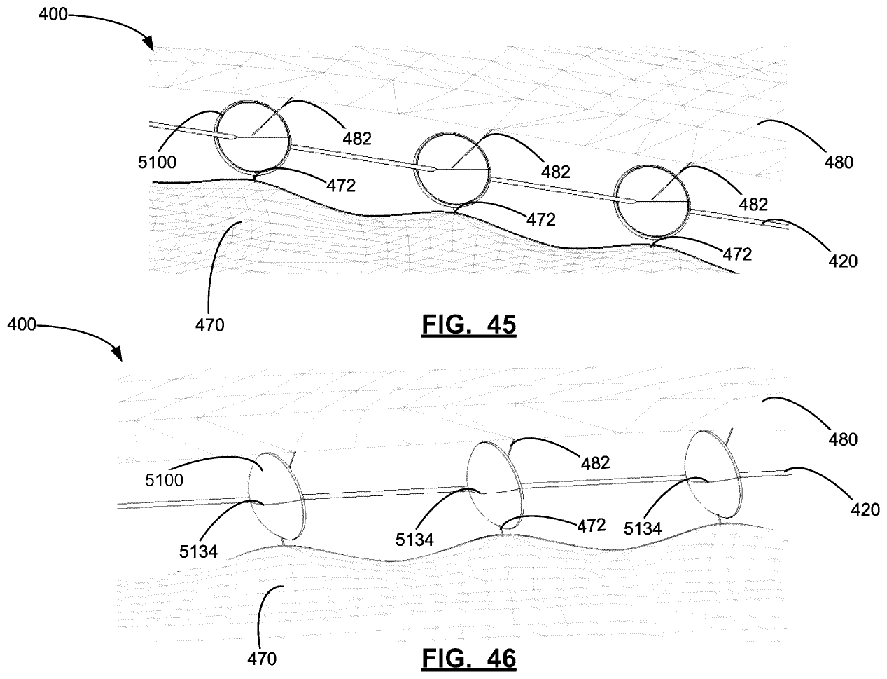

In some embodiments, the segments 5100 may be fixed to their respective bridle to maintain the desired incidence angle 5200. The segments 5100 may be moveable along the bridle and may be subsequently locked in place for use. For example, referring to FIGS. 45 and 46, as shown, the segment body 5101 has a seam 5134 that extends parallel to the passage 5132. The seam 5134 may be opened such that the passage 5132 is opened to receive a cable of the trawl net system. In other words, the segment 5100 may operate like a clam shell to open and receive one or more cables. Accordingly, the segments 5100 may be more easily repositioned along the cable. A user may open the clam shell segment, move the segment to a different position, and shut the clam shell over the cable, thereby fixing it in place.

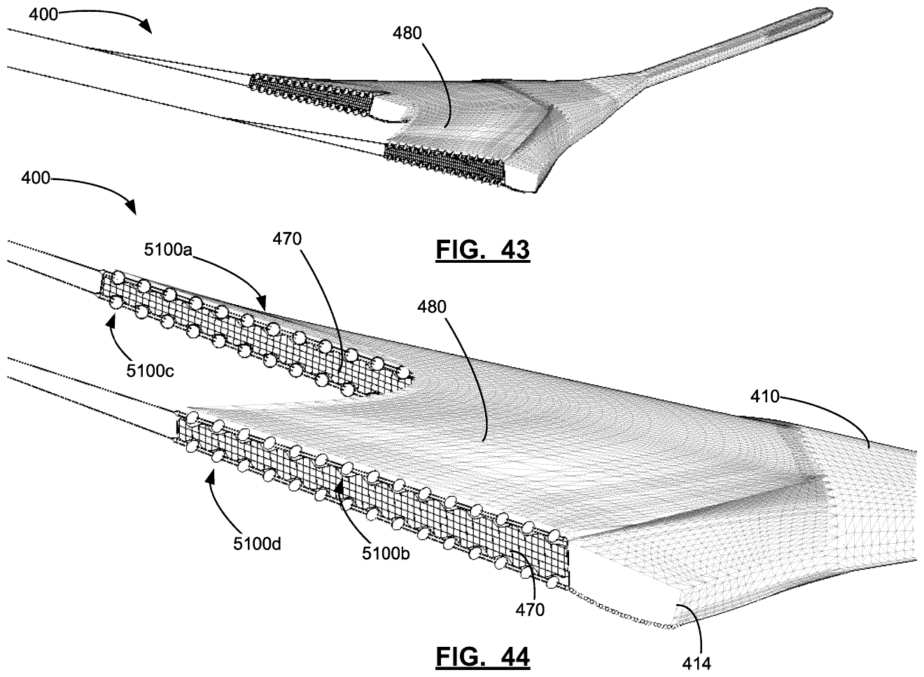

Referring to FIGS. 43-46, the trawl net system 400 may include a canopy net 480. The canopy net 480 may stretch from the first bridle 420 to the second bridle 430, to a top portion of the opening 416. As shown, the canopy net 480 may stretch across the entire upper portion of each top bridle. The canopy net 480 may improve the efficiency of the trawl net system 400 by helping to guide fish into the opening 416.

As shown in FIGS. 44 and 45, each segment 5100 may include a side net attachment 472 and a canopy attachment 482. The side net attachment 472 may be used to couple the side net 470 to the segment body 5101 and the canopy attachment 482 may be used to couple the canopy net 480 to the segment body 5101. In some embodiments, the side net attachment 472 and the canopy attachment 482 may be the same piece of material that is clamped through the openable segment, as shown in FIGS. 45 and 46.

In some embodiments, the overall weight of the trawl net system may be varied depending on the desired use of the system. For example, assuming there is a desired fishing depth at a desired boat speed and length of cable in the water, the overall net weight can be tuned to reach equilibrium at these desired operating conditions. One or more weights may be added to one or more regions of the trawl net system to tune the overall net weight. For example, a weight, such as a chain, may be attached to the lower bridles (third bridle 440 and fourth bridle 450) proximate the net 410.

Alternately, or in addition, the overall weight of the trawl net system may be controlled by varying the quantity and/or size of the segments. The size of the segments may vary the interior volume, thereby varying the buoyancy of each segment.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A segment for use in a trawl system having a cable and a longitudinal axis, the segment comprising:
a segment body having an inner side, and an outer side; and
at least one passage extending from the inner side to the outer side for receiving the cable of the trawl system;
wherein the segment body is hydrodynamically shaped such that the segment is adapted to be urged away from the longitudinal axis when the segment is pulled through water by the cable.

2. The segment of claim 1, wherein the segment body is shaped such that when the segment is pulled through water, the inner side forms a high pressure region and the outer side forms a low pressure region and a pressure gradient between the inner side and the outer side generates a lateral lift force that urges the segment in a direction away from the longitudinal axis.

3. The segment of claim 2, wherein the inner side of the segment body is generally planar.

4. The segment of claim 2, wherein the outer side of the segment body is generally convex.

5. The segment of claim 2, wherein the segment body is a spherical dome.

6. The segment of claim 1, wherein the at least one passage has a passage longitudinal axis that forms an incidence angle with a flow direction when the segment is pulled through water, and
wherein the incidence angle is based on a ratio of lateral lift force to drag force.

7. The segment of claim 6, wherein the incidence angle is in the range of about 0 to about 30 degrees.

8. The segment of claim 6, wherein the ratio is above about 1.5.

9. The segment of claim 1, wherein the at least one passage comprises a plurality of passages for receiving a plurality of the cables, wherein when each one of the plurality of passages receives a corresponding one of the plurality of cables, the segment is restrained from rolling.

10. A trawl net system, comprising:
a trawl net having a first side and a second side with an opening therebetween;
a first bridle adapted to be coupled to the first side and a second bridle adapted to be coupled to the second side, each bridle comprising at least one cable;
a first plurality of segments and a second plurality of segments, wherein each segment of the first and second plurality of segments comprises:
a segment body having an inner side, and an outer side; the segment body defining at least one passage extending therethrough from the inner side to the outer side for receiving the at least one cable;
wherein the first plurality of segments is positionable on the first bridle and the second plurality of segments is positionable on the second bridle,
wherein each segment body is hydrodynamically shaped such that the first plurality of segments and the second plurality of segments are adapted to be urged away from each other when the segments are pulled through water by the bridles.

11. The trawl net system of claim 10, wherein at least one of the first bridle and the second bridle comprises a plurality of cables and each segment in the corresponding plurality of segments comprises a plurality of passages for receiving the plurality of cables.

12. The trawl net system of claim 10, further comprising:
a third bridle couplable to the first side and a fourth bridle couple to the second side, each of the third and fourth bridles having the at least one cable;
a third plurality of the segments positionable on the third bridle and a fourth plurality of the segments positionable on the fourth bridle,
wherein the third plurality of segments and the fourth plurality of segments are adapted to be urged away from each other when the segments are pulled through water by the bridles.

13. The trawl net system of claim 12, wherein at least one of the first bridle, the second bridle, the third bridle, and the fourth bridle comprises a plurality of cables and each segment in the corresponding plurality of segments defines a plurality of passages for receiving the plurality of cables.

14. The trawl net system of claim 12, further comprising a first connecting cable for connecting the first bridle to the third bridle and a second connecting cable for connecting the second bridle to the fourth bridle.

15. The trawl net system of claim 10, wherein each segment has a center point and a length extending from a leading edge to a trailing edge and each plurality of segments is distributed along the respective bridle with an inter-segment distance that reduces shielding between adjacent segments.

16. The trawl net system of claim 15, wherein the inter-segment distance is greater than two lengths of the segment.

17. The trawl net system of claim 10, wherein the first side is a first lateral side and the second side is a second lateral side.
